(19) United States
(12) Patent Application Publication
(10) Pub. No.: US 2004/0136488 A1
(43) Pub. Date: Jul. 15, 2004

(54) Universal modular container for reactor pressure vessel heads

(75) Inventors: Peter T. Tuite, Cortlandt Manor, NY (US); Kevin T. Tuite, Cornwall, NY (US); Albert A. Freitag, Washingtonville, NY (US)

Correspondence Address: BROWN, RAYSMAN, MILLSTEIN, FELDER & STEINER LLP, 900 THIRD AVENUE, NEW YORK, NY, 10022, US

(73) Assignee: WMG, Inc., Peekskill, NY (US)

(21) Appl. No.: 10/625,484

(22) Filed: Jul. 22, 2003

(51) Int. Cl. G21C 19/00

(52) U.S. Cl. 376/272

(57) ABSTRACT

### Abstract of the Disclosure

A universal modular container for containing, transporting, storing, or disposing of reactor pressure vessel heads (RPVHs) with attached control rod driving mechanisms has several sections that may be handled independently and thus allow easier handling of the container and packaging of the RPVHs. Various ring sections of different lengths may be used, to allow the container to have dimensions that are the best match for enclosing any particular intact reactor pressure vessel head with attached control rod driving mechanisms. The RPVH with attached CRDMs can be placed onto and attached to a bottom plate of the container, items can be removed from the reactor pressure vessel head, and then the ring sections attached to the bottom plate. The container is closed with a top plate, and the complete package is ready to be transported for storage or disposal in accordance with regulations for radioactive materials.

### Detailed Description of the Invention

### Background of Invention

FIELD OF THE INVENTION

The invention generally relates to radioactive waste containers. In particular, the invention relates to methods and apparatus for the containment, transportation, storage and/or disposal of reactor pressure vessel heads.

BACKGROUND OF THE RELATED ART

There are about 100 nuclear power plants currently in operation within the United States. The nuclear reactor pressure vessels that form the hearts of these power plants are radioactive, and require special handling and containment when a power plant is serviced or decommissioned. Figure 1 is a cutaway schematic elevation view of a typical pressurized water type reactor pressure vessel 102. It comprises body 114 and head 115, internals 117, and a number of external fittings 103, including water nozzles 144 and control rod drive mechanisms 145. Head 115 is joined to body 114 at flange 146 by means of attachments 132, and insulation 116 is in place around exterior 105 of the reactor pressure vessel. Internals 117 comprise upper internals 147 and lower internals 148.

When a power plant is decommissioned, the conventional practice has been to package the entire reactor pressure vessel 202 (including the vessel head 115) and transport it for disposal. The reactor pressure vessel 202 is placed within another container adapted to provide both shielding and structural integrity for it during transport. In particular, the reactor pressure vessel 202 is disconnected from the control rod drive mechanisms 145 and piping 144 which connected it to the remainder of the power plant, and placed otherwise intact, with its internal components 117 in operating configuration, its pressure head 115 in place, and with its inlet and outlet nozzles untrimmed, within another container, encased in grout to hold it in place within one section of the container, and transported.

Fig. 2 illustrates the containment configuration used in the decommissioning of the Saxton power plant. Containment package 200 had reactor pressure vessel 202, with reactor pressure vessel head 215 firmly attached by head-to-body attachments 232, disposed within canister 201. Canister 201 had first and second sections 236 and 237, respectively. External fittings 203 to control rod drive mechanisms (CRDMs) were severed, but substantial portions 204 of the fittings and external insulation 206 were left in place. Interior 209 of reactor pressure vessel was left intact with all internals 217 (not shown in their entirety) and was filled with grout, and the gap 251 between body 214 and the canister was filled with grout. Surface contaminants were sealed by grout on interior surface 210 and on exterior surface 205. Exterior surface 213 of canister 201 had no fenders or other protection against shocks.

[Containment packages for reactor pressure vessels are shown, for example, in U.S. Patent No. 6,087,546 issued to Griffiths et al., and entitled "DECOMMISSIONED REACTOR VESSEL PACKAGE AND METHOD OF MAKING SAME" in U.S. Patent No. 6,414,211 issued to Lacy, assigned to Burns & Roe Enterprises, Inc., and entitled "METHOD OF PACKING A NUCLEAR REACTOR VESSEL FOR DECOMMISSIONING AND REMOVAL"; and in commonly-owned U. S. Patent Application Publication No. 2002/0177747, published 28 November 2002 and entitled "CONTAINMENT AND TRANSPORTATION OF DECOMMISSIONED NUCLEAR REACTOR PRESSURE VESSELS AND THE LIKE. The entire contents of the specification of U.S. Patent Application Publication No. 2002/0177747 are hereby incorporated by this reference.

Separate from instances of decommissioning a nuclear power plant, problems with Boron corrosion have led to a recent requirement by the U.S. Nuclear Regulatory Commission that, unless a pressurized water nuclear power plant owner can demonstrate no corrosion, the reactor pressure vessel head (RPVH) has to be replaced. Like the overall reactor pressure vessel, the head is generally radioactive due to activation and surface contamination and therefore requires special handling and containment. It is also relatively large (typically over 15 feet in diameter and 10 feet high) and heavy (60 to 75 tons). Thus, when it is moved for storage (or, in most cases equivalently, for disposal), the problems associated with its containment are compounded. Despite these problems, removal must be carried out in accordance with U.S. Department of Transportation (DOT) regulations for transporting radioactive materials.

Due to the corrosion issues, several reactor vessel heads have been removed and transported for disposal. These heads have had the CRDMs removed and were packaged outside containment. Now, in the interest of minimizing the extent of power plant outage schedules and personnel exposure to radiation, it is desired to remove and transport them intact, in other words, ship the RPVH plus the attached CRDMs as a single unit. This approach negates the lengthy time required to remove the CRDMs and the personnel radiation exposure incident to such removal.

Figure 3 illustrates a typical intact RPVH: an RPVH with its CRDMs attached. Although only a small number of CRDMs are shown in Fig. 3 for the sake of simplicity, it should be kept in mind that there are typically dozens of such CRDMs, a typical range being from 48 to 65 CRDMs. The addition of the CRDMs also greatly increases the overall length of the radioactive unit, to about 30 feet, and adds about 20 to 25 tons to the unpackaged payload. The RPVH alone in a shielded transport container may weigh about 100 to 120 tons. An intact RPVH (with attached CRDMs) packaged in an appropriately shielded and DOT permitted transport container may weigh 150 to 180 tons. The CRDMs also add radioactivity to the unit and, in some cases, will increase the radioactivity to a level where a DOT exemption will be required for transport.

The additional length and weight of the CRDMs presents problems. While containment apparatus and methods are generally known for large radioactive waste materials, a conventional container designed for containment of an intact RPVH (i.e., with attached control rod drive mechanisms) might be so large that it would be very difficult or impossible to fit the container inside the building containing the reactor pressure vessel during a refueling outage. Even if it does fit inside the building, a container of such length and weight is unwieldy and would be difficult to handle within the typical confines of a nuclear power plant during an outage.

The container for an intact RPVH must be able to handle the loads experienced during transport of such a heavy package. None of the known prior art adequately addresses the issues of size, weight, bulk, shock absorbency, or manageability for the containment and transport of RPVHs with attached control rod driving mechanisms.

Thus there is a need for suitable and efficient methods and apparatus for containing, storing, and transporting intact reactor pressure vessel heads together with the attached CRDMs as a single unit.

### Summary of Invention

BRIEF SUMMARY

It is an object of the preferred embodiments of the invention to provide methods and apparatus for containing, transporting, storing, and disposing of intact reactor pressure vessel heads from pressurized water reactors with attached control rod drive mechanisms.

It is another object of the preferred embodiments of the invention to provide an apparatus that is modular in nature so that it can be brought into the building containing the reactor pressure vessel during a refueling outage and the intact RPVH can be packaged while inside the building, thereby reducing schedule risk and radiation exposure to personnel during refueling outages.

It is another object of the preferred embodiments of the invention to provide an apparatus having a universal design so that it can be re-used if the intact RPVH is transported to a radioactive waste processor instead of a radioactive waste disposal site.

It is another object of the preferred embodiments of the invention to provide an apparatus that can be used to receive an intact RPVH while in a reactor building and can also be used to transport the intact RPVH on a transport conveyance, such as a heavy haul truck trailer or a barge.

It is another object of the preferred embodiments of the invention to provide methods and apparatus which result in lighter and safer packages and which still provide adequate shielding and containment and also meet federal and state requirements for transport, storage, and disposal of an intact RPVH.

It is another object of the preferred embodiments of the invention to provide such methods and apparatus, which result in smaller, and more easily, safely, and economically handled packages for containment, transport, storage, and disposal of an intact RPVH.

It is another object of the preferred embodiments of the invention to provide such methods and apparatus, which result in packages having improved shock absorption and dissipation characteristics during transport of an intact RPVH.

It is another object of the preferred embodiments of the invention to provide light, safe, durable, and effective containers for intact RPVHs and the like, which are economically and reliably produced and easy to deploy.

These and other objects are achieved by the apparatus and methods of the preferred embodiments disclosed herein for containing, transporting, and storing or disposing of reactor pressure vessel heads, in particular intact reactor pressure vessel heads. An improved, economically-produced, modular container is provided which allows easier and more efficient handling and packaging of RPVHs within buildings, and which provides improved shock absorption and attenuation characteristics, especially when packaging is complete. The RPVH and its attached CRDMs are disconnected and removed from the remainder of the reactor pressure vessel and prepared for packaging in the modular container. The container, prepared in a plurality of, and preferably at least three, sections, each section preferably comprising a plurality of pieces to be assembled at the site of the packaging in order to ease handling and packaging of the RPVH and CRDMs, is brought into the building and placed near the RPVH. The RPVH is placed onto a bottom plate portion of the container, and the other sections of the container are subsequently attached so that the container is complete and substantially encloses the device. Optionally the RPVH and/or the attached CRDMs are covered with a protective covering such as an anti-contamination sock, which is placed around the RPVH and/or CRDMs as the container is built around the RPVH and CRDMs. The built-up container containing the RPVH and CRDMs may be filled with a support or stabilizer substance such as a grout or low-density cellular concrete to aid in sealing surface radioactive particles in place and to help support and to help secure the RPVH inside the container. The container is closed and any penetrations through its exterior are sealed. The packed and sealed container is then ready to be transported to a storage location, stored on site, or transported to a processor or disposal site.

In one aspect the invention provides a universal modular container, preferably comprising several sections that may be handled independently and thus allow easier handling and packaging of the container to where the reactor is installed within a building. Once in position, the sections may be pre-assembled to form rings of a container. Various ring sections of different lengths may be used to allow the resulting container to have dimensions that are the best match for enclosing any particular intact reactor pressure vessel head with attached control rod driving mechanisms. The intact reactor pressure vessel head can be placed onto and attached to a bottom plate of the container, items can be removed from the reactor pressure vessel head, and then the ring sections attached to the bottom plate. The container is preferably closed with a top plate, and the complete package is ready to be transported for storage or disposal in accordance with regulations for radioactive materials.

Preferably containers according to the invention are provided in a plurality of flanged, generally tubular sections, each section comprising one or more pieces assembled at the packaging site, with suitable closure portions. The flanged sections are preferably fabricated so that when assembled they form a generally tubular container of suitable size and shape to adequately contain the removed RPVH and its attached CRDMs, the ends of the container being closeable by bottom and lid sections. The bottom, flanges, and lids are adapted to mate with each other to form sealing surfaces and to facilitate attachment of the various sections in assembly of the container. Suitable sealants such as fixative sprays, gaskets, and the like, may be used to ensure adequate radiation containment by providing suitable levels of gamma shielding and the like. Adequate standards of radiation containment may be defined, for example, by government regulations for the containment, transportation, storage, and/or disposal of radioactive items.

### Brief Description of Drawings

BRIEF DESCRIPTION OF THE DRAWINGS

A preferred embodiment of the invention is illustrated in the figures of the accompanying drawings which are exemplary and not limiting, in which like references are intended to refer to like or corresponding parts.

Figure 1 is a cutaway schematic elevation view of a typical reactor pressure vessel.

Figure 2 is a cutaway schematic elevation of a prior art nuclear reactor pressure vessel containment package.

Figure 3 is a partial cutaway schematic of the top of a pressurized water reactor pressure vessel head with its control rod drive mechanisms attached.

Figure 4A is a perspective view of a bottom plate of a universal modular container in accordance with a preferred embodiment of the invention.

Figure 4B is a perspective view of a lower ring of a universal modular container in accordance with a preferred embodiment of the invention.

Figure 4C is a perspective view of a mid ring of a universal modular container in accordance with a preferred embodiment of the invention.

Figure 4D is a perspective view of an upper ring of a universal modular container in accordance with a preferred embodiment of the invention.

Figure 5 is a schematic view of a reactor pressure vessel head disposed within a universal modular container in accordance with a preferred embodiment of the invention.

### Detailed Description

DETAILED DESCRIPTION OF THE PREFERRED EMBODIMENTS

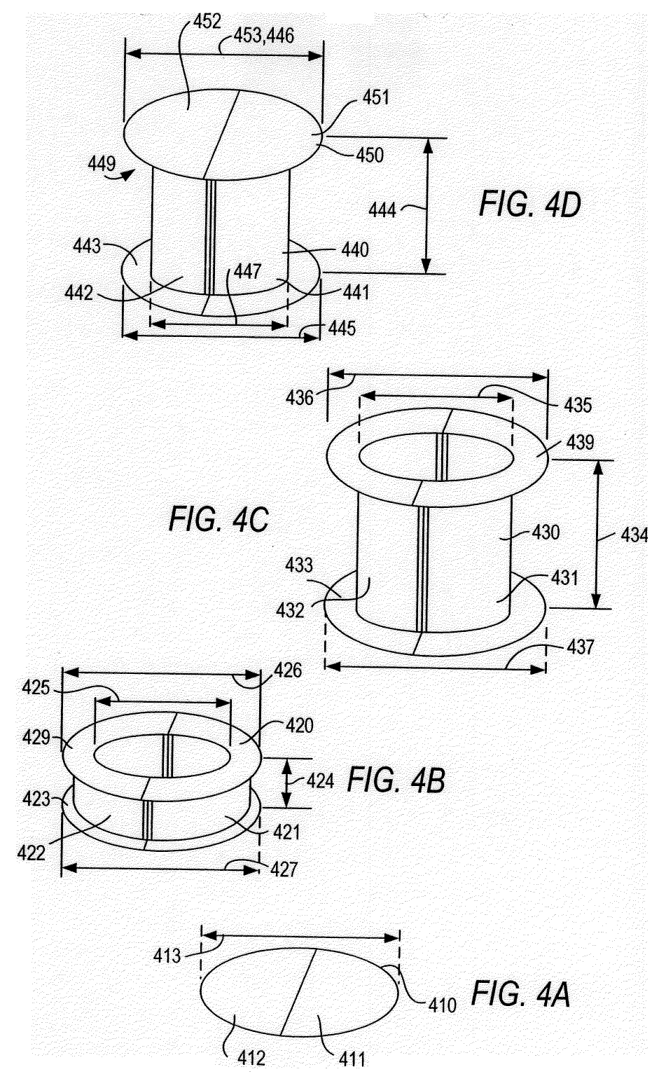

Figs. 4A-4D show the basic components of a universal modular shielded transport container 400 for intact RPVHs according to a preferred embodiment of the invention. Container 400 comprises a bottom plate 410, a plurality of generally tubular sections 420, 430, 440, and lid 450. Each of bottom plate 410, tubular sections 420, 430, and 440, and lid 450 comprises a plurality of pieces 411, 412; 421, 422; 431, 432; 441, 442; and 451, 452, respectively, the number and respective dimensions of which are selected based on the geometry of the RPVH, the CRDMs, the removal site, and other conditions imposed by a particular RPVH removal process. The selection of suitable numbers and dimensions of the pieces of container 400 will be well within the understanding of a designer having ordinary skill in the art, once the designer has been made familiar with this disclosure.

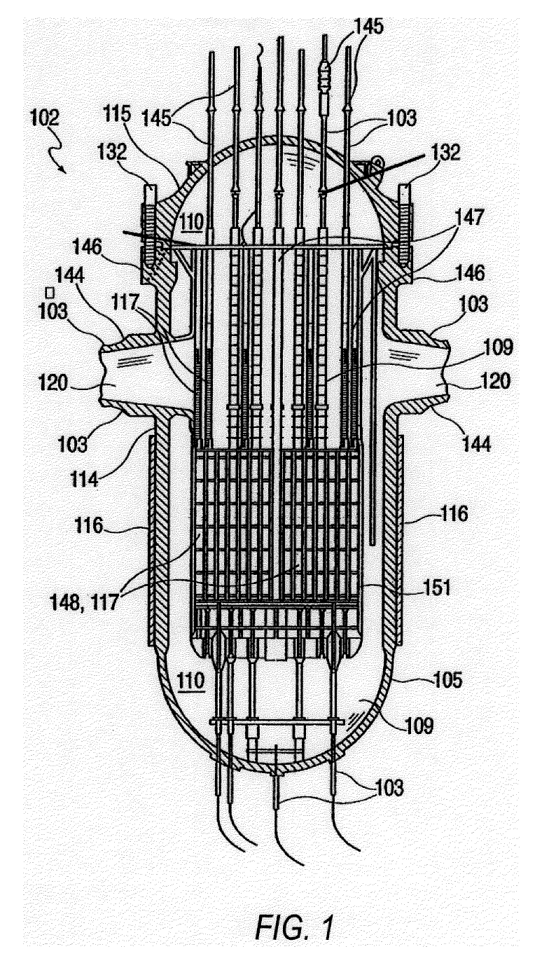

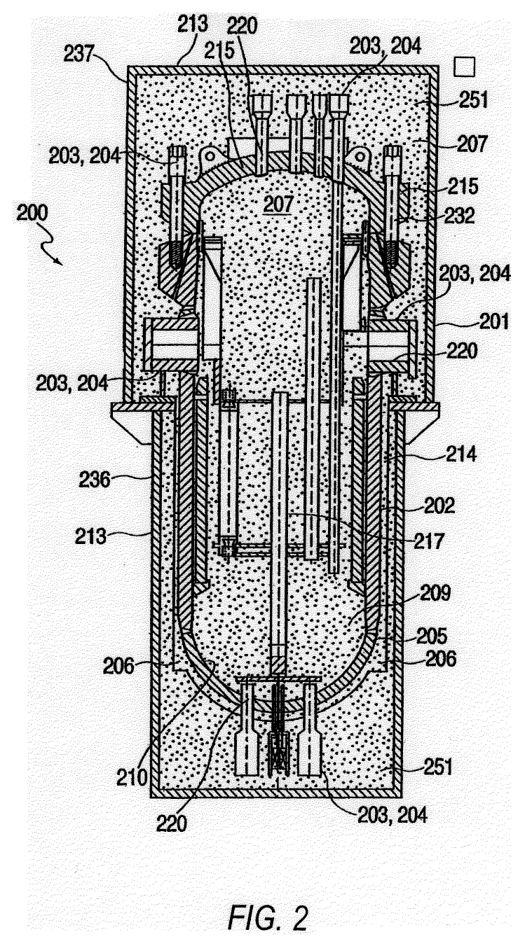

Fig. 4A shows two pieces of a bottom plate 410. When assembled, bottom plate 410 comprises a diameter 413 suitable for attachment and containment of the RPVH and/or any other suitable RPV components, and for sealing attachment of the bottom plate 410 to flange 423 of lower ring section 420. Bottom plate 410 is of a gauge suitable, in view of the material(s) of which it is fabricated, to provide suitable strength, corrosion resistance, and radioactive shielding properties, as discussed herein, and may include any suitable means for attachment of the intact RPVH, for example, holes that are sized and positioned to accept attachment fittings present on the intact RPVH (e.g., attachments 132 in Fig. 1).

Fig. 4B shows two pieces making up a lower ring 420. When assembled, lower ring 420 comprises flanges 423, 429, inner diameter 425, and length 424 suitable for accommodation of the removed RPVH and/or portions of the attached CRDMs or other suitable components; and outer diameters 426, 427 of flanges 423, 429 suitable for sealing attachment of section 420 to bottom plate 410 and to flange 433 of middle section 430.

Fig. 4C shows two pieces making up a middle ring 430. When assembled, middle ring 430 comprises flanges 430, 439, inner diameter 435, and length 434 suitable for accommodation of the removed RPVH and/or portions of the attached CRDMs or other suitable components, and outer diameters 436, 437 of flanges 433, 439 suitable for sealing attachment of section 430 to lower ring 420 and to flange 443 of upper ring section 440.

Fig. 4D shows pieces making up a lid 450 and two pieces making up an upper ring 440. When assembled, lid 450 and upper ring 440 comprise inner diameter 445 and length 444 suitable for accommodation of portions of the attached CRDMs and/or other suitable components, and outer diameters 445, 453 suitable for sealing attachment of section 440 to middle ring 430 and to lid 450.

Sections 410, 420, 430, 440, and lid 450 are fabricated of material(s) of gauge(s) suitable, in view of the material(s) of which they are fabricated, to provide suitable strength, corrosion resistance, and radioactive shielding properties, as discussed herein. Peripheral ports may be provided in one or more of the lid, bottom, or ring sections 410-450 for filling any gaps between the interior of container 400 and the RPV exterior. The lid, bottom, or ring sections may also include vent ports and / or other access holes or penetrations.

Diameters 413, 427, 426, 437, 436, 447, 446, and 453 of bottom plate 410, flanges 423, 429, 433, 439, 443, 449 of ring sections 420, 430, 440, and of lid 450, configurations, and gauges of the materials thereof, may also be selected to provide protection for container 440 and its contents from shocks, etc., for example, by acting as fenders or shock absorbers as herein described. For example, flanges of substantially constant widths, relative to the inner diameters of the tubular interior(s) of the container, such as those shown in Figures 4A 4D, may be used, or non-constant flange widths, comprising, for example, regular or irregular protuberances, may be used.

Joints between bottom plate 410, flanges 423, 429, 433, 439, 443, 449, and lid 450; and other joints or penetrations of container 400, may be sealed by any suitable means using any suitable process and materials. For example, gaskets or O-rings may be placed between contacting surfaces, or other sealants may be employed. Such gaskets or O-rings and other sealants are composed of any suitable materials, such as for example neoprene, rubber, nylon, butyl-N, or Teflon. Selection of suitable sealing materials will be within the skill of designers of ordinary skill familiar with this disclosure.

It should be understood that container 400 is not limited to the substantially tubular shape with circular sections or to the number of rings shown in Figs. 4A-4D. In particular, any number of rings may be fabricated for the container. Furthermore and preferably, rings of different lengths may be fabricated so that is possible to vary the length of the assembled container so as to be universally applicable and best fit any individual RPVH.

The interior of container 400 may be adapted by size and geometric configuration to minimize the gap between an intact RPVH and the sides of the container, but is preferably large enough for such radioactive item to be disposed within container 400 without difficulty, and to allow the addition of a stabilizer in any gap(s) 251 between the RPVH or other components and any portions of container 400. The selection of suitable dimensions and geometry is not difficult once the dimensions and geometry of the intact RPVH are known. The exterior may include integral sacrificial fenders located adjacent the bottom plate 410 and/or the top plate 450. Sacrificial fenders can be fabricated, for example, using extensions of the bottom plate 410, top plate 450, and/or the flanges of the various tubular sections 420, 430, 440; that is, beyond those portions of container 400 actually used for containing the radioactive item, and are adapted to absorb or dissipate shocks administered to the completed containment package by deforming under contact loads. The mechanics of such fenders and their role in attenuating or absorbing shocks are well understood and will be plain to those of skill in the art, given the disclosure herein.

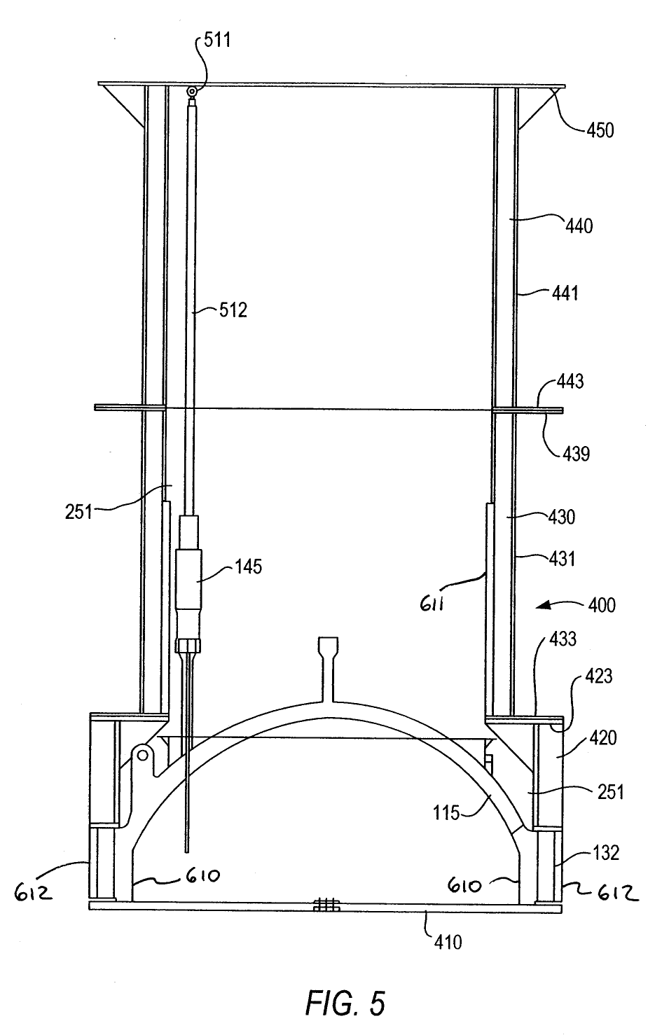

Any one or more portions of container 400 may comprise secondary shields. Secondary shields are advantageously employed to supplement the basic container shielding on an as-needed basis. Preferably, circumferential shields are employed in conjunction with shields on top plate 450 and/or bottom plate 410. An advantage of using substantially cylindrical containers is that secondary shields are relatively simple to fabricate and install. In the case of circumferential shields, open-ended cylinders of nearly the same size and radius as the container may be employed, and may be disposed around the inner or outer surfaces of the container, at any axial position along the container that may be desired. See, e.g., shield 611 of Fig. 5. Shields on top plate 450 or bottom plate 410 may be fabricated from flat plate material merely by trimming them to size, and may be placed at any axial location within the container or covering one or both of top plate 450 and bottom plate 410. In either case it is often suitable, as will be understood by those having ordinary familiarity with the art of radiation shielding, that the same or different materials as those employed in fabricating the container may be used in fabricating secondary shield structures, with substantial savings in cost. Secondary shields on top plate 450 and bottom plate 410 are particularly useful for reducing radiation levels during transport and storage.

This design configuration has several advantages. For example, by providing the container in separate components, such as sections 420-440, lid pieces 450, and base pieces 410, it is more practical to bring the container 400 into the building containing the reactor pressure vessel even though it must have a sufficient length to enclose an intact RPVH with attached control rod driving mechanisms. Consequently, the intact RPVH can be packaged while inside the containment building, thereby reducing risks from radiation exposure; and any accommodations such as modifications to existing plant or containment building structures for removal of the container may be made while the RPVH assembly is being packaged, thereby improving outage schedules. Where container components are provided in sections, they can be assembled by any suitable process, such as welding, at any suitable point during the packaging process.

Because the length of the container configuration can be varied by selection of various available ring sections of differing lengths, there is no need to create a customized container for each operation. Also, the radioactivity levels are not as high for some parts of the intact RPVH as for the core region of the reactor pressure vessel, and it is possible that some of the parts of the intact RPVH may be disposed as non-radioactive materials by a radioactive waste processor. The universal modular container 400 has the advantage that it can be re-used if, for example, the intact RPVH is transported to a radioactive waste processor instead of a radioactive waste disposal site.

Furthermore, the container design configuration allows the container 400 to be assembled even though the intact RPVH is first placed on a transport conveyance such as a truck trailer or a barge. When the sections are assembled and attached as described below, the universal design meets the DOT general design criteria for radioactive materials packages that can be used for shipment of a variety of different intact RPVHs with attached CRDMs.

The container 400 is substantially easier and less expensive to fabricate than prior art containments. This is in large part due to its simplified construction, as described. The design has the further advantage that it provides for variable gamma radiation shielding that permits packaging with the ability to provide the additional shielding necessary for regulatory compliant transport. It is also economical to use, especially during the containment and removal of intact RPVH"s, because it may easily be separated into sections, moved into place, and assembled easily.

Container 400 can serve both as primary structure for lifting, handling, and transport of the radioactive items packaged within them, and as the primary containment boundary between the intact RPVH and the environment. This can be accomplished by using any of a wide range of known materials, including structural steel. Any materials having sufficient radioactive shielding and structural strength qualities will serve. The selection of suitable materials and gages will not trouble designers of ordinary skill in the art, once they have been made familiar with this disclosure.

The ring sections 420-440 may be fabricated economically and easily by rolling or otherwise forming a tubular body by conventional means from sheet or plate metal. They, lid 450, and bottom plate 410, are preferably fabricated of carbon steel with appropriate levels of radioactive shielding. Integral fenders are easily formed in such processes by suitable sizing of lid, bottom, and section diameters, leaving protruding material to act as the fenders protruding or extending from the body of the container. An optional fillet, which can be readily formed by rolling or other conventional means, is particularly beneficial, as it permits provision of integral fenders, in such fashion that fenders are able to perform their function with full efficiency, while optionally permitting the container weight and the weight of any of its contents to be transferred directly to the floor or other surface on which the container and any contents are placed, without passing through and possibly harming the fenders or reducing their capacity to absorb or dissipate shocks. Optionally fenders are of sufficient depth to allow them to provide protection to the containment package as a whole, as well as to the RPVH. It has been found that ASTM A-36, A516 GR 70, A-572 and A592 steel plate of between preferably two to four inches" thickness can meet the structural and shielding requirements of the invention, subject to regulator standards and requirements, as will be understood by those familiar with the art.

As previously indicated, sections and other portions of container components 410 450 may be assembled and attached to each other using any suitable processes, such as welding and or bolting.

A preferred method of packaging an intact RPVH in container 400 is as follows. The method described can be altered in order and other particulars to accommodate plant specific and other unique conditions.

A first stage of the packaging sequence is preparation and pre-assembly. Bottom plate 410 is moved into the building near the intact RPVH. As shown in Fig. 4A, bottom plate 410 may be composed of two half-circular sections. Next, a protective covering such as an anti-contamination sock is moved into the building near the intact RPVH. The anti-contamination sock preferably is fabricated of synthetic sheet materials of various thicknesses, and can comprise three pieces: a bottom, a center "tube" section, and a top. The two half sections of the bottom plate 410 are then assembled. The remaining container sections of rings 420-440 and the top plate 450 are moved into the building and assembled in series.

Typically, power plants contain some access, such as sealable service doors or hatches, for moving equipment into and out of the reactor containment building. Preferably, the preferred embodiment of the invention makes it possible to use an existing access. However, the access into or out of the building may be of any suitable type and, if necessary, additional access may be provided to the extent necessary to complete the removal of the intact RPVH packaged in the container, for example by temporarily or permanently enlarging access or service doors or hatches, or making temporary or permanent holes in containment walls. In any event, as discussed above, the different sections of the container according to the preferred embodiment may be moved into the building in sequence and thus make it easier to conduct preparation and pre-assembly.

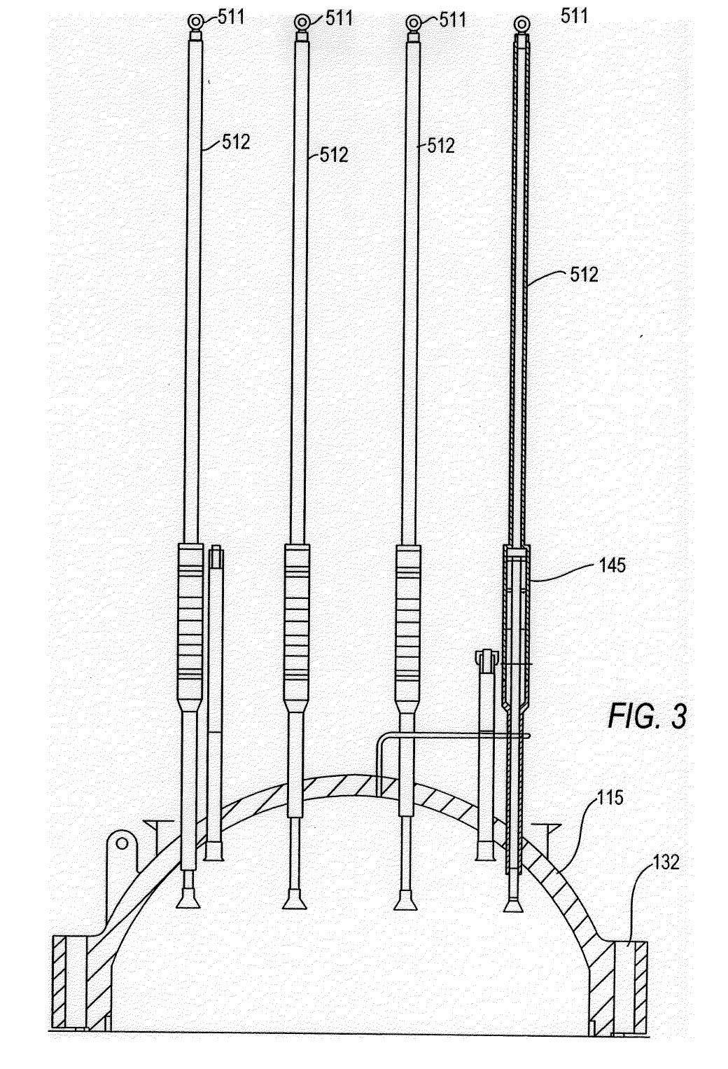

Next, or preferably concurrently, the intact RPVH removal stage is performed. Any external parts which are not to be removed and shipped with the RPVH may be removed, preferably to the extent that such parts protrude further from said reactor pressure vessel head than the outer perimeter of the head-to-body joint flange 146 (Fig. 1). All CRDMs to be removed and packaged with the RPVH are disconnected from portions which are not to be removed, preferably by disconnecting the CRDMs at the ends 511 of the control rods 512 from any further drive or control mechanisms. As will be apparent to those familiar with this disclosure, however, the CRDMs may be disconnected at other points while retaining the advantages offered by the invention. The external surfaces of the intact RPVH may be sealed with paint or other suitable substance to immobilize surface contaminants. The bottom plate 410 is set onto a surface such as a transport conveyance (e.g., transfer cart with removal frame and trunnions) located near the reactor. The bottom of the anti-contamination sock is placed onto the bottom plate 410 and optionally sealed around stud bosses provided on bottom plate 410, for example for attachment of the RPVH to the bottom plate using existing RPVH attachment structures 132 (see, e.g., Fig. 3). The studs are installed in the bottom plate 410 (making sure that the packaged RPVH can be lifted high enough to clear the studs after setting it on the transport conveyance). A lifting device, such as a crane, is attached to the intact RPVH, lifts it up, removes it from the remainder of the reactor pressure vessel, and sets it onto the transport conveyance (preferably, over the studs and onto the bottom plate 410 and the bottom portion of the containment sock).

Certain elements may be removed from the RPVH, preferably after the RPVH removal process is performed. These removed elements may comprise, for example, RPI coils, service support structure, head shielding, the shroud, baffles, and CRDM eyebolts. There is no requirement to remove any certain combination of elements from the RPVH. However, the primary concerns are to reduce the size and weight of the resulting container package to the extent practical and consistent with the objects indicated herein. A secondary concern is whether any elements may be recycled and/or reused, in which case those elements are preferably removed. For example, the RPIs and RPI coils, and possibly the stators, may be recycled and/or reused.

The cylindrical "tube"section of the anti-contamination sock is installed over the CRDMs and attached to the anti-contamination sock skirt flange (temporarily attaching to the top of the CRDMs). The bottom ring section 420 of the package is lowered over the CRDMs and onto temporary blocking. Fixative spray is applied to the vertical face of the flange and onto the head dome up to and including the anti-contamination sock skirt flange. Ring section 420 is lifted, the blocking is removed, the bottom portion of the anti-contamination sock is folded up onto the head flange 146 (Fig. 1), and then the ring section 420 is lowered onto the head flange. If necessary or desired, the sock may be cut to go over existing studs coming through the head flange 146 from the bottom plate 410. Bottom plate 410 is bolted or otherwise attached to the head flange and if used the nuts are torqued. The middle ring section 430 of the package is lowered over the CRDMs and onto the rim 610 of RPVH 115, so that outer or corner portion 612 of rim 610 is exposed (see, e.g., Fig. 5). The ring 430 is bolted or otherwise attached to the lower ring 420 and if used the nuts are torqued. The upper ring section 440 of the packaging is lowered over the CRDMs and onto the ring 430. The upper ring 440 is bolted or otherwise attached to the middle ring 430 and if used the nuts are torqued. A CRDM tube sheet is installed onto the top of the CRDMs (it may rest on blocks attached to the inside of upper ring 440). The top end of the "tube" section of the anti-contamination sock is fixed to the CRDM tube sheet. The top of the anti-contamination sock is installed to the top of the CRDM tube sheet. The top plate 450 is installed onto the upper ring 440. The top plate 450 is bolted or otherwise attached to the upper ring 440 and if used the nuts are torqued.

Prior to transport, a stabilizer such as with low density cellular concrete or other suitable substance may be introduced in the gap between the intact RPVH and the interior wall of container 400. The stabilizer may substantially fill the gap between the container and the intact RPVH. Optionally, the entire interior of the container may be filled with the stabilizer, to further immobilize contaminants and stored components. After the gap has been filled to a level at least sufficient to allow the stabilizer to support the intact RPVH and the stabilizer allowed time to set sufficiently, the container 400 may be moved, such as by being pivoted, etc. The transport conveyance is then moved from the reactor building and the container 400, with the intact RPVH inside, may be transferred to an appropriate transport such as a truck or barge, and transported to a disposal site.

The container 400 may be moved, such as by being pivoted, etc. The container 400, with the intact RPVH inside, may be transferred to an appropriate transport such as a truck or barge, and transported to a disposal site.

It is important to note that except as inherently required by the processes themselves, the order in which the steps of the methods described herein are performed is not necessarily of any significance. In many instances, it is possible or even desirable to change the order of the steps. Those cases in which it is or is not possible to alter the order of steps will be apparent to those of ordinary skill in the relevant arts as they contemplate carrying out the processes.

An example of an alternative process starting at the RPVH removal stage is as follows. The lower section of an anti-contamination sock is set on the transport conveyance. The bottom plate 410 is set on the transport conveyance. The studs are installed into bottom plate 410. The RPVH is removed from the remainder of the reactor pressure vessel, set on bottom plate 410 and disassembled to remove certain elements, as previously discussed. The tube sock is installed over the CRDMs and cinched at the top of the CRDMs. The tube sock is secured to the shroud support with a metal ring or band. The top of the tube sock is preferably made with cinch rope. Also, the top of the tube sock is preferably made larger in diameter to allow easy fit up over the tube sheet. The lower ring 420 is installed and bolted down. The middle ring 430 is installed and bolted down. The upper ring 440 is installed and bolted down. The tube sock is un-cinched from the top of the CRDMs and pulled back to the full diameter of the upper ring 440. The tube sheet is set onto the CRDMs and the tube sock is re-cinched over the tube sheet and CRDMs. If required, a top anti-contamination sock can be placed over the cinched area and secured to the tube sock. The top plate 450 is installed onto the upper ring 450. The top outer section of anti-contamination sock is installed and connected to the lower outer section of the anti-contamination sock.

There must be sufficient headroom to allow a crane to lift the RPVH to be lifted up and moved to the transport conveyance. There must also be sufficient head room to allow a crane to lift the container sections 420-440 over the CRDMs and lowered onto the RPVH. These clearances of course depend on the height of the crane, the transport conveyance, and the intact RPVH with attached CRDMs. Also, scaffolding or some other means should be available for installation of an anti-contamination sock, and the container ring sections.

An essential advantage of the universal modular container design and the packaging process is that it minimizes or eliminates the spread of radioactive contamination during packaging within the building containing the nuclear reactor and subsequent transfer from the building to an outside transport conveyance. Furthermore, the methods of cylindrical section longitudinal and horizontal attachment and closure, and flat section attachment, can withstand the loads associated with DOT transport for IP-2 packages.

Preferred embodiments of the various structures disclosed herein are fabricated from any materials having sufficient strength, durability, corrosion resistance, and radioactive shielding qualities to serve the purposes described for such structures. Suitable materials are known, and have been identified herein where appropriate; but any materials having suitable qualities will serve.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is Claimed is:

1. WHAT IS CLAIMED IS:
1. A method of containing a reactor pressure vessel head with attached control rod mechanisms for transport as radioactive materials, the method comprising:
coating exterior surfaces of the reactor pressure vessel head with a fixative material;
packaging the control rod drive mechanisms within a protective covering;
attaching the reactor pressure vessel head to a bottom plate; and
placing the reactor pressure vessel head within a transport container while the reactor pressure vessel head is in a reactor containment building.

2.
2. The method of Claim 1, wherein said reactor pressure vessel head comprises the reactor pressure vessel head of a pressurized water reactor vessel.

3.
3. The method of Claim 1, comprising coating exterior surfaces of said pressure vessel head with sealant.

4.
4. The method of Claim 1, comprising filling a gap between the pressure vessel head, the control rods, and the container with a stabilizer.

5.
5. The method of Claim 4, wherein filling said gap with stabilizer comprises filling said gap with low density cellular concrete.

6.
7. The method of Claim 1, wherein said transport container comprises multiple modular sections.

7.
8. The method of Claim 1, comprising filling at least a portion of said intact reactor pressure vessel head with a stabilizer.

8.
9. A method of containing a reactor pressure vessel head with attached control rod mechanisms for transport as radioactive materials, the method comprising:
using a multi-piece universal container to permit access of the container parts into the building containing the reactor;
using a two-piece bottom plate to permit unencumbered shipment from a fabricator and to provide access into the building containing the reactor; and
sealing the container using a series of flanged and gasketed surfaces.

9.
10. The method of Claim 9, comprising coating exterior surfaces of the reactor pressure vessel head with sealant.

10.
11. The method of Claim 9, comprising filling a gap between the pressure vessel head, the control rods, and the container with a stabilizer.

11.
12. The method of Claim 9, comprising sealing said container.

12.
13. The method of Claim 9, wherein said reactor pressure vessel head is the reactor pressure vessel head of a pressurized water reactor vessel.

13.
14. The method of Claim 9, comprising filling at least a portion of said intact reactor pressure vessel head with a stabilizer.

14.
15. The method of Claim 11, wherein filling said gap with stabilizer comprises filling said gap with low density cellular concrete.

15.
16. A method of sealing joints of a container for a reactor pressure vessel head with attached control rod mechanisms using gasket configurations that provide for gamma shielding, the method comprising:
defining joints perpendicular to the container axis with semicircular plates welded to the container section flanges;
defining joints parallel to the container axis with rectangular plates welded to the container section flanges;
locating the semicircular plates used for sealing inside the diameter of the rectangular plates used for sealing.

16.
17. The method of Claim 16, comprising coating an interior surface of said reactor pressure vessel head with sealant.

17.
18. The method of Claim 16, comprising substantially filling a gap between the interiors of said container and said reactor pressure vessel head with a stabilizer.

18.
19. The method of Claim 16, wherein said filling said gap with stabilizer comprises filling said gap with low density cellular concrete.

19.
22. The method of Claim 16, comprising filling at least a portion of said reactor pressure vessel head with a stabilizer.

20.
24. The method of Claim 16, wherein said intact reactor pressure vessel head comprises the reactor pressure vessel head of a pressurized water reactor vessel.

21.
25. Apparatus for the containment and transport of a reactor vessel pressure head with attached control rod mechanisms as radioactive materials, the apparatus comprising:
a plurality of partial circular sections attached to each other and to the reactor pressure vessel head;
a bottom plate attached to the pressure vessel head in a corner configuration adapted to minimize and/or absorb shocks; and
a plurality of protuberances surrounding the reactor pressure vessel head to absorb shock.

22.
26. The apparatus of Claim 25, wherein said reactor pressure vessel head comprises the reactor pressure vessel head of a pressurized water reactor vessel.

23.
28. The apparatus of Claim 25, wherein said plurality of partial circular sections are attached to each other in series.

24.
29. The apparatus of Claim 25, further comprising a stabilizer, which is introduced in a gap between an interior of said sections and said pressure vessel head.

25.
30. The apparatus of Claim 25, wherein said reactor pressure vessel head comprises a head-to-body attachment.

26.
31. The apparatus of Claim 30, wherein said reactor pressure vessel head is attached to said bottom plate.

27.
32. The apparatus of Claim 25, wherein said apparatus comprises a canister when assembled.

28.
33. A method of fabricating a containment vessel for use in removing a reactor pressure vessel head with attached control rod mechanisms from a nuclear power plant, the method comprising:
fabricating a plurality of semi-circular flanged components having respective cross sections of sufficient dimensions to accommodate the reactor pressure vessel head, from sheet material;
fabricating a plurality of partial cylinder sections, each partial cylinder section suitable for transit through a reactor containment building access hatch;
transporting said partial cylinder sections to the power plant site in a truck; and
transporting a two piece bottom plate to the power plant site in a truck.

29.
34. The method of Claim 33, wherein said components are assembled in series to form a tubular body inside said reactor containment building vessel.

30.
35. A method of packaging a nuclear reactor pressure vessel head with attached control rods as radioactive material, comprising:
providing, in a structure containing a nuclear reactor pressure vessel having a head, a plurality of components of a multi-component container;
removing the pressure vessel head from the pressure vessel with at least one control rod attached; and
attaching at least one of the plurality of components to at least one of the pressure vessel head and another of the plurality of components while the plurality of components and the pressure vessel head are in containment.

31.
36. The method of claim 35, comprising assembling remaining components of the multi-component container about the pressure vessel head and the at least one attached control rod to contain the pressure vessel head and the at least one control rod.

32.
37. The method of claim 36, wherein the assembling remaining components of the multi-component container about the pressure vessel head and the at least one attached control rod to contain the pressure vessel head and the at least one control rod is performed in the containment structure.

33.
38. The method of claim 36, wherein the assembling remaining components of the multi-component container about the pressure vessel head and the at least one attached control rod to contain the pressure vessel head and the at least one control rod comprises attaching at least one of the components outside the containment structure.

34.
39. The method of claim 35, wherein the plurality of components comprises an anti-contamination sock.

35.
40. The method of claim 39, wherein the attaching at least one of the plurality of components to at least one of the pressure vessel head and another of the plurality of components comprises covering at least a portion of at least one of the pressure vessel head and the at least one control rod with the anti-contamination sock.

36.
41. The method of claim 35, comprising coating at least a portion of an exterior of the pressure vessel head with a fixative.

37.
42. The method of claim 35, comprising disconnecting the at least one control rod from another mechanism.

38.
43. The method of claim 42, wherein the another mechanism comprises a drive mechanism.

39.
44. The method of claim 42, wherein the disconnecting the at least one control rod from another mechanism comprises severing the control rod.

40.
45. The method of claim 35, wherein the attaching at least one of the plurality of components to at least one of the pressure vessel head and another of the plurality of components comprises attaching the pressure vessel head to a component using structures on the pressure vessel head adapted for attachment of the head to the pressure vessel.

41.
46. The method of claim 35, wherein at least one of the components comprises a flange, and the method comprises providing a seal between the flange and another component.

42.
47. The method of claim 45, wherein the seal comprises a gasket.

43.
48. A method of packaging a nuclear reactor pressure vessel head with attached control rods as radioactive material, comprising:
bringing into a structure containing a nuclear reactor pressure vessel having a head a plurality of components of a multi-component container, the components including a bottom section, one or more cylindrical sections, and a top section;
removing the pressure vessel head from the pressure vessel with a plurality of control rods attached;
attaching the pressure vessel head to the bottom section inside the containment building;
disposing the one or more cylindrical sections about the plurality of control rods;
attaching the one or more cylindrical sections to at least one of the pressure vessel head and the bottom section; and
attaching the top section to the one or more cylindrical sections to enclose the pressure vessel head and attached control rods.

44.
49. The method of claim 48, comprising assembling at least one of the bottom section, the one or more cylindrical sections, and the top section from one or more parts.

45.
50. The method of claim 48, wherein at least one of the components comprises a flange, and the method comprises providing a seal between the flange and another component.

46.
51. The method of claim 50, wherein the seal comprises a gasket.

47.
52. The method of claim 48, comprising covering at least a portion of the plurality of attached control rods with a protective covering.

48.
53. The method of claim 52, wherein the protective covering comprises an anti-contamination sock.

49.
54. The method of claim 48, comprising coating at least a portion of an exterior of the pressure vessel head with a fixative.

50.
55. The method of claim 48, comprising disconnecting the plurality of control rods from other mechanisms.

51.
56. The method of claim 55, wherein the disconnecting the plurality of control rods from other mechanisms comprises severing at least one control rod.

52.
57. The method of claim 48, wherein at least one cylindrical sections or the top section is attached outside the containment structure.

53.
58. A method of packaging a nuclear reactor pressure vessel head with attached control rods as radioactive material, comprising:
covering with a protective cover at least a portion of at least one of:
a pressure vessel head of a nuclear reactor pressure vessel, and
a plurality of control rods attached to the pressure vessel head;
removing the pressure vessel head with the plurality of attached control rods from the nuclear reactor pressure vessel;
assembling a multi-component container about the pressure vessel head and the attached control rods.

54. 59. The method of claim 58, wherein the protective cover comprises an anti-contamination sock.

55. 60. The method of claim 58, wherein the protective cover comprises temporary shielding.

56. 61. The method of claim 58, wherein at least one component of the multi-component container is configured to pass through an existing access to a structure containing the nuclear reactor pressure vessel.

57. 62. The method of claim 58, wherein the covering with a protective cover is at least partly performed inside a containment structure.

58. 63. The method of claim 58, wherein the assembling a multi-component container is at least partly performed inside a containment structure.

59. 64. The method of claim 58, wherein the covering with a protective cover is at least partly performed outside a containment structure.

60. 65. The method of claim 58, wherein the assembling a multi-component container is at least partly performed outside a containment structure.

61. 66. The method of claim 58, wherein at least one of the components of the multi-component container comprises a flange, and the method comprises providing a seal between the flange and another component.

62. 67. The method of claim 66, wherein the seal comprises a gasket.

63. 68. A multi-component container for a nuclear reactor pressure vessel head with attached control rods, comprising:
a bottom component adapted for attachment to a nuclear reactor pressure vessel head; and
at least one cylindrical component configured for at least partial containment of at least one control rod attached to the pressure vessel head; at least one of the components configured to pass through an existing access to a structure containing a nuclear reactor pressure vessel, and for attachment to at least one of the pressure vessel head and the another component inside the containment structure.

64. 69. The container of claim 68, comprising a top component adapted for attachment to the at least one cylindrical section.

65. 70. The container of claim 68, wherein at least two of the components comprise flanges adapted for attaching the components to each other.

66. 71. The container of claim 70, wherein the flanges are adapted for providing a seal between the flanges when the components are attached.

67. 72. The container of claim 71, wherein the flanges are adapted for attaching a first cylindrical component to a second cylindrical component.

68. 73. The container of claim 71, wherein the flanges are adapted for attaching a cylindrical component to at least one of a bottom component and a top component.

69. 74. The container of claim 71, wherein the seal comprises a gasket.

70. 75. The container of claim 71, wherein the seal comprises at least one of neoprene, rubber, nylon, butyl-N, and Teflon.

71. 76. The container of claim 68, wherein at least one of the components comprises a flange adapted for absorbing shocks.

72. 77. The container of claim 68, wherein at least one of top component and the bottom component are circular when the container is assembled.

73. 78. The container of claim 68, wherein the at least a portion of the container is of circular cross section when the container is assembled.

74. 79. The container of claim 68, wherein the at least a portion of the container is of non-circular cross section when the container is assembled.

75. 80. The container of claim 68, comprising at least one cylindrical component configured to contain at least a portion of the reactor pressure vessel head.

76. 81. The container of claim 68, wherein at least one of the bottom component, the top component, and the at least one cylindrical component is provided in one or more parts configured for passing through an access in the containment structure prior to assembly of the container.

77. 82. The container of claim 68, wherein the bottom component is adapted for attachment to the pressure vessel head using structures on the pressure vessel head adapted for attachment of the head to the pressure vessel.

78. 83. The container of claim 68, wherein the bottom component comprises bosses configured for attachment to structures on the pressure vessel head adapted for attachment of the head to the pressure vessel.

79. 84. A multi-component container for a nuclear reactor pressure vessel head with attached control rods, comprising:
at least one cylindrical component configured for at least partial containment of at least one control rod attached to the pressure vessel head; at least one of the components configured to pass through an existing access to a structure containing a nuclear reactor pressure vessel, and for attachment to at least one of the pressure vessel head and the another component inside the containment structure; and
at least one secondary shield adapted for disposition adjacent to an inside or outside surface of a portion of the container.

80. 85. The container of claim 84, wherein the at least one secondary shield comprises a cylindrical component adapted for disposition adjacent to an inner or outer surface of a cylindrical portion of the container.

81. 86. A container for use in packaging a nuclear reactor pressure vessel head with attached control rods for transport as radioactive material, the container comprising a plurality of components configured to pass through an existing access to a structure containing a nuclear reactor pressure vessel, and for containing a plurality of control rods attached to the pressure vessel head.

82. 87. A container for use in packaging a nuclear reactor pressure vessel head with attached control rods for transport as radioactive material, the container configured for: c
containing a plurality of control rods attached to the pressure vessel head;
attachment to at least one surface of the pressure vessel head; and
leaving a portion of the pressure vessel head exposed.
